(19) United States
(12) Patent Application Publication
(10) Pub. No.: US 2015/0314326 A1
(43) Pub. Date: Nov. 5, 2015

(54) METHOD FOR MANUFACTURING PLANARIZED FABRIC SUBSTRATE FOR FLEXIBLE DISPLAY

(71) Applicant: KOLON GLOTECH, INC., Gwacheon-si, Gyeonggi-do (KR)

(72) Inventors: Byong-Cheul PARK, Seosan-si (KR); Beob PARK, Yongin-si (KR); Kwang Taeg RYU, Yongin-si (KR)

(73) Assignee: KOLON GLOTECH, INC., Gwacheon-si, Gyeonggi-do (KR)

(21) Appl. No.: 14/647,190

(22) PCT Filed: Dec. 17, 2012
(86) PCT No.: PCT/KR2012/011031

§ 371 Date: May 26, 2015

(30) Foreign Application Priority Data
Dec. 17, 2012 (KR) 10-2012-0147389

(51) Int. Cl. B05D 3/14

(52) U.S. Cl. CPC B05D 3/148

(57) ABSTRACT

Disclosed herein is a method for manufacturing a fabric substrate for a flexible display. According to the present invention, the method comprises the steps of preparing step for preparing a fabric substrate, calendering step for thermal stability and dimensional stability of the fabric substrate, a first coating step for coating a first planarization layer for planarizing the calendered fabric substrate, a plasma processing step for processing plasma to the first planarization layer, and a second coating step for coating a second planarization layer on the plasma-processed first planarization layer.

### TECHNICAL FIELD

The present invention relates to a method for planarizing a fabric substrate for a flexible display based on a fiber texture, in particularly, a method for planarizing a fiber substrate for improving smoothness, thermal stability, and dimensional stability for securing integrity of elements.

### BACKGROUND ART

Flexible displays are displays which are thin like papers and curved, bended, and rolled through flexible substrates without damages. In order to materialize these flexible displays, LCD (Liquid Crystal Display), OLED (Organic Lighting Emitting Diodes (OLED), and Electric Paper Display (EPD) like flat-panel displays have been classified and developed.

Recently, there are many advantages in flexible displays such as light weight, thin thickness, and infrangibility by employing plastic or film materials. For this reason, these flexible displays are considered as displays for mobile devices. Also, since they have high design freedom such that shapes can be changed, these flexible displays have increased demand for household items, automotive applications, and so forth.

In a conventional art, rollable keyboards as an input device made of fabrics manufactured by Eleksen company have been introduced, and smart shirts capable of embodying bio-signal monitoring and information processing using optical and conductive fabrics in school of polymer and Textile & Fiber Engineering of GIT (Georgia Institute of Technology).

However, there are limitations of flexible displays employing plastic and film materials. There are disadvantages in that the flexible displays do not have drapability, and flexibility is not exploited. Accordingly, flexible displays using fabric substrates in which flexibility can be maximumly utilized have been studied.

Substrates for display devices require smoothness for preventing integrity of coating such as conductive coating about electrodes.

Recent fabric substrates are not enough to be used as display substrates in respect of smoothness, thermal stability, and dimensional stability.

### DISCLOSURE

### Technical Problem

The inventors of the present invention completed the present invention resulting from efforts to develop an inorganic layer that is formed by coating ionized metal compound on a surface of a transparent substrate film and naturally cured so as to react with moisture in air.

Another object of the present invention is to provide a transparent flexible film that can be produced at a low cost without using high cost of deposition apparatus and a method thereof.

### Technical Solution

Embodiments of the present invention provide a method for manufacturing a fabric substrate for a flexible display comprising the steps of preparing step for preparing a fabric substrate, calendering step for thermal stability and dimensional stability of the fabric substrate, a first coating step for coating a first planarization layer for planarizing the calendered fabric substrate, plasma processing step for processing plasma to the first planarization layer, and a second coating step for coating a second planarization layer on the plasma-processed first planarization layer.

Pursuant to some embodiments of the present invention, the fabric substrate is formed of at least one or two or more mixture from the group consisting of polyethylene terephthalate, polyethylene, nylon, and acryl.

Pursuant to some embodiments of the present invention, the calendering step is processed at a temperature ranged from 40° C. to 180° C. and under the condition of 1.5 to 3.5 kg/cm².

Pursuant to some embodiments of the present invention, a thermal stability has a temperature being more than 300° C. when a weight reduction is 0.2% and a coefficient of thermal expansion (CTE) ranged from 10 to 40 ppm/° C.

Pursuant to some embodiments of the present invention, the first planarization layer is formed of at least one or two or more mixture from the group consisting of silane, polyurethane, and polycarbonate.

Pursuant to some embodiments of the present invention, the silane is formed of at least one or two or more mixture from the group consisting of monosilane (SiH₄), trisilane (Si₃H₈), and tetrasilane (Si₄H₁₀).

Pursuant to some embodiments of the present invention, the silane includes at least one function group selected from the group consisting of epoxy, alkoxy, vinyl, phenyl, methacryloxy, amino, chlorosilane, chloropropyl, and mercapto.

Pursuant to some embodiments of the present invention, the first planarization layer further includes at least one or two or more inorganic mixture from the group consisting of metal oxide, non-metal oxide, nitride, and nitrate.

Pursuant to some embodiments of the present invention, the first coating step forms the first planarization layer using one of a spin-coating, a slot-coating, and a bar-coating and cured at a low temperature ranged from 80° C. to 160° C.

Pursuant to some embodiments of the present invention, the first planarization layer has a thickness of 10 μm to 60 μm and a surface having Ra value of 1 μm to 5 μm.

Pursuant to some embodiments of the present invention, the plasma-processing step is processed in ambient gases of argon (Ar) and oxygen (O₂), a power of 50 to 300 W, and a room temperature plasma at atmospheric temperature.

Pursuant to some embodiments of the present invention, after the plasma processing step, wherein a contact angle of the first planarization layer is less than 10 to 60 degree.

Pursuant to some embodiments of the present invention, the second planarization layer further includes at least one or two or more inorganic mixture from the group consisting of acrylate-based polymer, epoxy-based polymer, amine-based oligomer, and vinyl-based polymer.

Pursuant to some embodiments of the present invention, the second planarization layer further includes a light absorbing agent.

Pursuant to some embodiments of the present invention, the second planarization layer further includes at least one or two or more inorganic mixture from the group consisting of metal oxide, non-metal oxide, nitride, and nitrate.

Pursuant to some embodiments of the present invention, the second coating step forms the second planarization layer using one of a spin-coating, a slot-coating, and a bar-coating and cured at a low temperature ranged from 80° C. to 160° C.

Pursuant to some embodiments of the present invention, a thickness of the second planarization layer has a thickness of 0.01 μm to 1 μm and a surface having Ra value of 10 μm to 500 μm.

Pursuant to some embodiments of the present invention, a flexible display device including the planarized fabric substrate for the flexible display is further included.

### Advantageous Effects

The present invention has the following effects.

First, according to a method for manufacturing a planarized fabric substrate for a flexible display, smoothness, thermal stability, and dimensional stability can be improved through planarization process. Thus, it is possible to replace a conventional display substrate by a flexible display substrate, so that a design freedom becomes increased to be applicable to various fields.

In addition, the planarized fabric for the flexible display substrate displays for clothes is very suitable for displays for clothes due to excellent flexibility, elasticity, and skin contact by drapability of fabric substrates

Further, the planarized fabric substrate for the flexible display has high smoothness, and thereby preventing integrity and shorting by step difference in forming pixels.

### DESCRIPTION OF DRAWINGS

FIG. 1 is a flowchart illustrating a method for manufacturing a planarized fabric substrate of a flexible display according to the present invention.

FIG. 2 is a cross-sectional view showing a cross section of a planarized fabric substrate of a flexible display according to the present invention.

FIG. 3 is a scanning electron microscope (SEM) photograph showing a cross section of a fabric substrate before planarization according to the present invention.

FIG. 4 is a graph illustrating coefficient of thermal expansion (CTE) of a planarized fabric substrate of a flexible display according to the present invention.

FIG. 5 is a graph illustrating thermal stability of a planarized fabric substrate of a flexible display according to the present invention.

FIG. 6 is a scanning electron microscope (SEM) photograph showing a cross section of a fabric substrate where a first planarization layer is formed according to the present invention.

FIG. 7 is a scanning electron microscope (SEM) photograph showing a cross section of a fabric substrate where a second planarization layer is formed according to the present invention.

FIG. 8 shows an organic emitting device (OED) formed on a planarized fabric substrate for a flexible display according to the present invention.

FIG. 9 shows an embodiment of an organic emitting device (OED) formed on a planarized fabric substrate for a flexible display according to the present invention.

<Brief explanation of essential parts of the drawings>

| | |
|---|---|
| 100: Fabric Substrate | 200: First Planarization Layer |
| 300: Second Planarization Layer | |

### BEST MODE

The terminology which is used in common will be used for the purpose of description and not of limitation. Furthermore, terms and words used by the applicant may be used for special cases. In this case, the meaning of terms or words must be understood with due regard to the meaning expressed in the specification rather than taking into account only the basic meaning of the terms and words.

Hereinafter, the technical construction of the present invention will be described in detail with reference to preferred embodiments illustrated in the attached drawings.

The present invention may, however, be embodied in different forms and should not be construed as limited to the embodiments set forth herein. The same reference numeral is used to refer to like elements throughout.

As used herein, the terms “about”, “substantially”, etc. are intended to allow some leeway in mathematical exactness to account for tolerances that are acceptable in the trade and to prevent any unconscientious violator from unduly taking advantage of the disclosure in which exact or absolute numerical values are given so as to help understand the invention.

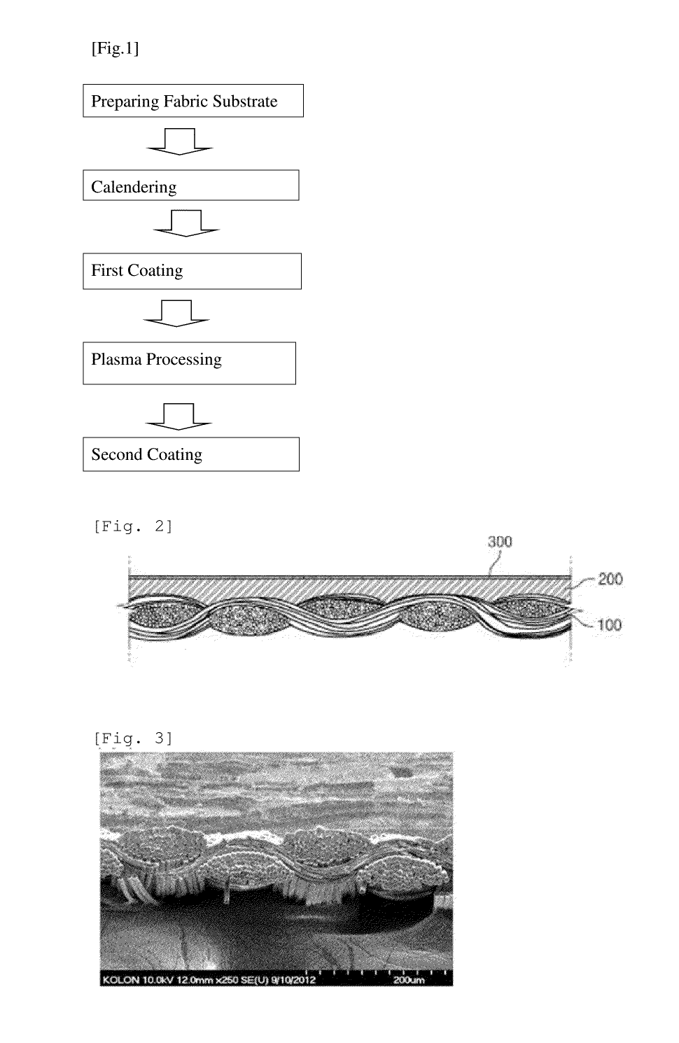

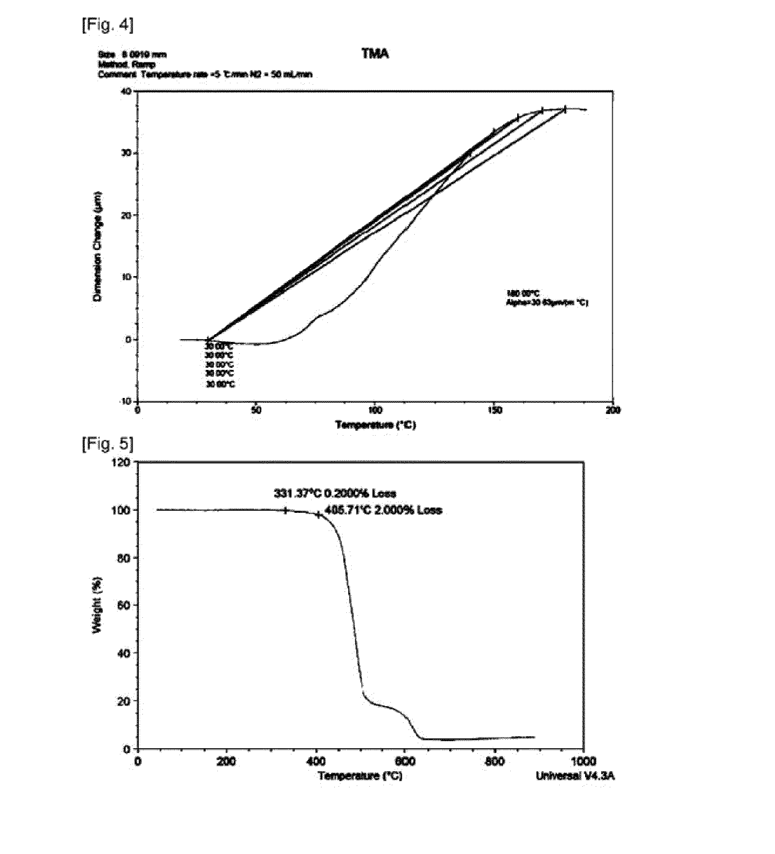

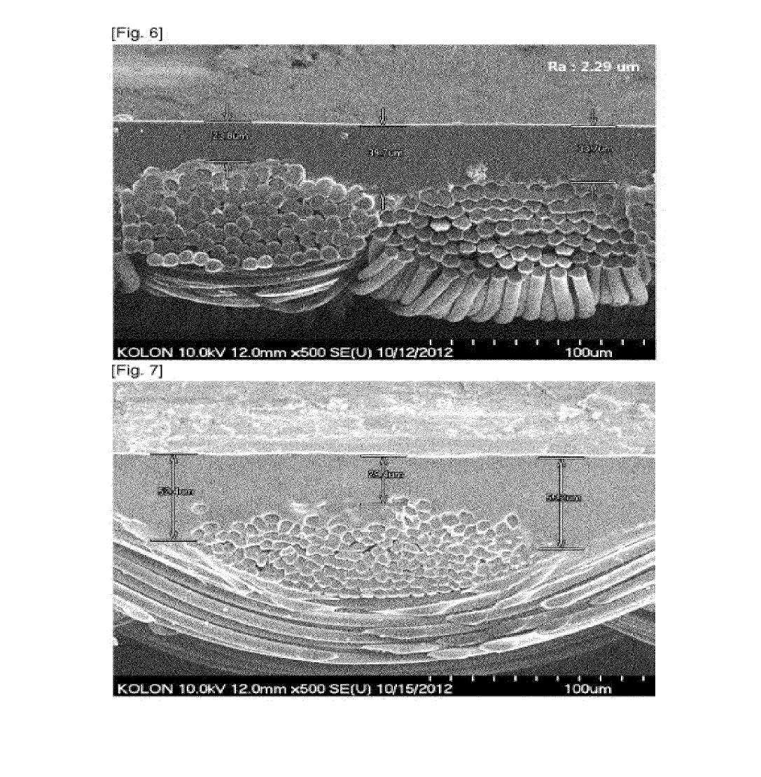

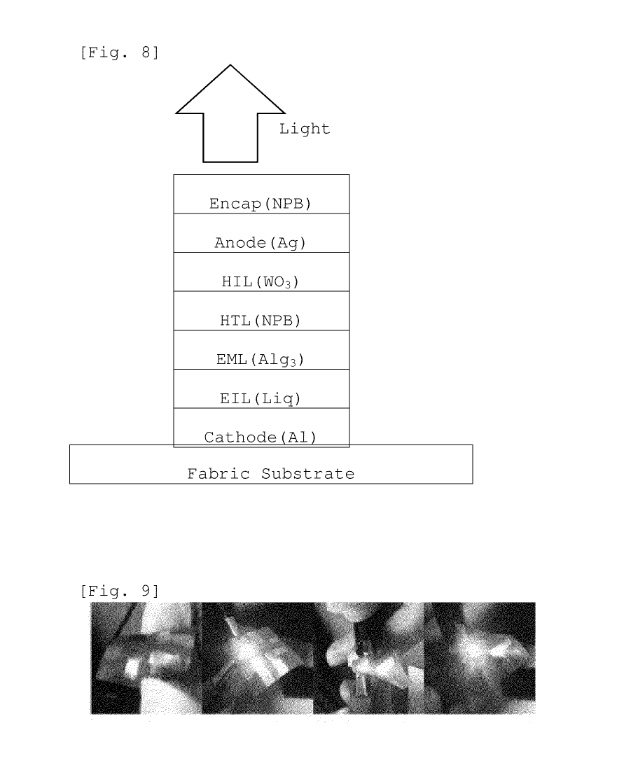

FIG. 1 is a flowchart illustrating a method for manufacturing a planarized fabric substrate of a flexible display according to the present invention. FIG. 2 is a cross-sectional view showing a cross section of a planarized fabric substrate of a flexible display according to the present invention. FIG. 3 is a scanning electron microscope (SEM) photograph showing a cross section of a fabric substrate before planarization according to the present invention. FIG. 4 is a graph illustrating coefficient of thermal expansion (CTE) of a planarized fabric substrate of a flexible display according to the present invention. FIG. 5 is a graph illustrating thermal stability of a planarized fabric substrate of a flexible display according to the present invention. FIG. 6 is a scanning electron microscope (SEM) photograph showing a cross section of a fabric substrate where a first planarization layer is formed according to the present invention. FIG. 7 is a scanning electron microscope (SEM) photograph showing a cross section of a fabric substrate where a second planarization layer is formed according to the present invention. FIG. 8 shows an organic emitting device (OED) formed on a planarized fabric substrate for a flexible display according to the present invention. FIG. 9 shows an embodiment of an organic emitting device (OED) formed on a planarized fabric substrate for a flexible display according to the present invention.

The present invention relates to a fabric substrate for a flexible display manufactured using fabrics, as shown in FIG. 1, and is manufactured by steps of a preparing step, a calendering step, a first coating step, and a plasma processing step, and a second coating step. As shown in FIG. 2, the planarized fabric substrate for a flexible display is formed of a fabric substrate 100, a first planarization layer 200, and a second planarization layer 300.

It is preferable that fabrics used in the fabric substrate 300 are fabrics formed of synthetic resins. The preparing step is to prepare the fabric substrate 100. The fabric substrate 100 is formed of at least one or two or more mixture from the group consisting of polyethylene terephthalate, polyethylene, nylon, and acryl. In addition, the fabric substrate 100 is formed using fabrics formed by polyethylene terephthalate, polyethylene, nylon, and acryl in a weaving or knitting way.

It is preferable to use polyethylene terephthalate having excellent properties among synthetic resins.

The calendering step is for thermal stability and dimensional stability of the fabric substrate and rolls the fabric substrate using two or more rollers. It is preferable that the calendering step is processed at a temperature ranged from 40° C. to 180° C. and under the condition of 1.5 to 3.5 kg/cm² for thermal stability and dimensional stability.

After the calendering step, the thermal stability of the fabric substrate may have a temperature being more than 300° C. when a weight reduction is 0.2% and a coefficient of thermal expansion (CTE) ranged from 10 to 40 ppm/° C.

The first coating step is to coat the first planarization layer 200 for planarizing the calendered fabric substrate.

In the first coating step, the first planarization layer 200 is formed in various ways such as a spin-coating, slot-coating, a bar coating, and so forth. It is preferable that the first planarization layer 200 is cured at a low temperature ranged from 80° C. to 160° C. in order to be strongly adhered to the fabric substrate, prevent crack, and be flowed to enhance smoothness.

Preferably, the first planarization layer 200 has a thickness of 1 μm to 20 μm. To enhance smoothness, the first planarization layer 200 has a surface having Ra value of 1 μm to 5 μm.

Preferably, the first planarization layer 200 is formed of at least one or two or more mixture from the group consisting of silane, polyurethane, and polycarbonate.

The silane is formed of at least one or two or more mixture from the group consisting of monosilane (SiH₄), trisilane (Si₃H₈), and tetrasilane (Si₄H₁₀).

Additionally, the silane includes at least one function group selected from the group consisting of epoxy, alkoxy, vinyl, phenyl, methacryloxy, amino, chlorosilane, chloropropyl, and mercapto to raise functionality of the first planarization layer 200.

The first planarization layer 200 includes at least one or two or more inorganic mixture from the group consisting of metal oxide, non-metal oxide, nitride, and nitrate. Preferable examples of the inorganic mixture are aluminum oxide (i.e., Al₂O₃), silicon oxide (i.e., SiO₂), silicon nitride (i.e., SiNₓ), silicon oxidenitrides (i.e., SiON), magnesium oxide (i.e., MgO), indium oxide (i.e., MgF₂), and so forth.

The inorganic mixture forms an inorganic thin-film protecting layer to reduce surface roughness caused by defects such as pinholes, grain boundary, and cracks of the first planarization layer 200. Also, the inorganic mixture blocks penetrating paths of moisture and oxygen to improve resistance properties of the fabric substrate with respect to the inorganic mixture.

The plasma processing step varies surface tension of the first planarization layer 200 through plasma processing the first planarization layer 200 at a room temperature, so that the second planarization layer is strongly adhered to the first planarization layer 200. Preferably, the plasma-processing step is processed in ambient gases of argon (Ar) and oxygen (O₂), a power of 50 to 300 W, and a room temperature plasma at atmospheric temperature.

After plasma processing step, a contact angle of the first planarization layer is less than 10 to 60 degree.

The second coating step is to coat the second planarization layer 300 on the plasma processed first planarization layer 200.

In the second coating step, like the first coating step, the second planarization layer 300 is formed in a way selected from the group consisting of a spin-coating, a slot-coating, a bar-coating, and so forth. The second planarization layer 300 is cured at a low temperature ranged from 80° C. to 160° C. to improve smoothness and prevent cracks thereof.

Preferably, the second planarization layer 300 has a thickness of 0.01 μm to 1 μm and a surface having Ra value of 10 μm to 500 μm.

Preferably, the second planarization layer 300 includes at least one or two or more inorganic mixture from the group consisting of acrylate-based polymer, epoxy-based polymer, amine-based oligomer, and vinyl-based polymer.

The second planarization layer 300 further include light absorbing agent. The light absorbing agent enables the second planarization layer 300 to be photo-cured by free radical reaction initiated by photodegradable path, and the mixture ratio thereof can be varied by final characteristics.

By using a photo-curing way, the surface energy of the planarization layer is improved, and the planarization layers can be formed repeatedly in comparison with a conventional thermal-curing way. Highly cross-linking effect is expected, and thereby improving stability and reliability of devices.

Like the first planarization layer 200, the second planarization layer 300 may include at least one or two or more inorganic mixture from the group consisting of metal oxide, non-metal oxide, nitride, and nitrate so as to improve resistance characteristic by forming an inorganic thin-film protecting layer. The inorganic mixture is preferably aluminum oxide (i.e., Al₂O₃), silicon oxide (i.e., SiO₂), silicon nitride (i.e., SiNₓ), silicon oxidenitrides (i.e., SiON), magnesium oxide (i.e., MgO), indium oxide (i.e., MgF₂), and so forth.

The planarized fabric substrate for a flexible display having excellent thermal stability, dimensional stability, and smoothness is suitable for electronic devices including electron, photon, and optical assembly, preferably suitable for display devices (including wearable display devices), photovoltaic cells, and semiconductor devices.

The terms and expressions which have been employed here are used as the electronic devices used in the present invention are essential features indicating device including at least elastomeric substrates and electronic circuits. Also, the display devices may include conductive polymer.

Preferably, the display devices are electroluminescence (EL) (in particularly, Organic Lighting Emitting Device (OLED)), electrophoretic display (E-paper), Liquid Crystal Display (LCD) or electro-wetting display devices, photovoltaic cells, or electronic display devices including semiconductor devices (i.e., organic field effect transistors, thin-film transistors and integrated circuits)

The OLED is a display device including electroluminescence layer arranged between two layers in which each of two layers includes electrodes. A flexible display device may be formed by connecting OLED to the planarized fabric substrate and then combining them with a cover substrate.

In addition, the photovoltaic cell device may be formed by connecting devices including conducting-polymer layers arranged between two layers in which each of two layers includes electrodes and then combining them with a cover substrate.

The present invention will be explained later in detail. However, it is to be understood that the scope of the invention is not limited to the disclosed embodiments.

### MODE FOR INVENTION

### Example

A calendering step was processed with respect to a fabric substrate formed by polyethylene terephthalate at a temperature of 150° C. and under the condition of 3.0 kg/cm².

After the calendering step, the dimensional stability and thermal stability of the fabric substrate were shown in FIGS. 3 and 4, respectively.

After that, a slot coating was performed with respect to silane with epoxy functional group on a surface of the fabric substrate at room temperature. A first-coating step for curing and drying was performed during 3 minutes at a temperature of 150° C. While curing, a first planarization layer flowed to fill curved portions.

After forming the first planarization layer, smoothness (Ra) value, thickness of thin-film, a cross-section image of SEM were shown in FIG. 5.

A plasma-processing step with respect to the first planarization layer at room temperature was performed in ambient gases of argon (Ar) of 7 Lpm and oxygen (O₂) of 30 scm, a power of 200 W, at a speed of 30 mm/s, and at atmospheric temperature. After that step, a contact angle is less than 60 degrees.

After the plasma-processing step, a second coating step forming a second planarization layer formed by spin-coating acrylate-based polymers was performed under curing condition in which temperature was 150° C. and time was 30 minutes. After forming the second planarization layer, smoothness (Ra) value, thickness of thin-film, a cross-section image of SEM were shown in FIG. 6.

An organic light emitting device (OLED) was formed on the planarized fabric substrate for the flexible display according the present invention. The structure of the OLED was shown in FIG. 7. An embodiment of the fabric substrate combined with the OLED was shown in FIG. 8

### Evaluation Method

1. CTE (Coefficient of Thermal Expansion)

A dimensional stability of the fabric substrate measured by CTE was measured as followings. A thermos-mechanical analyzer (PE-TMA-7, Perkin Elmer) was calibrated and checked with respect to temperature, displacement, force, eigendeformation, standard, and temperature adjustment in a well-known manner. Fabrics are inspected using an extension analysis clamp. Criteria required to the extension analysis clamp was obtained using an expansion sample (Quartz) having very low coefficient. Then, the precise and accuracy of CTE was evaluated using a standard material in which CTE value thereof is well known, for instance, pure aluminum foil.

A sample selected from a known alignment axis in an original film sample was mounted to a system by using a clamp-separating method in which the size of the clamp was approximately 12 mm. An applied force of 75 mN was applied with respect to 5 mm width of the sample. In order to secure consistent tension, an applied force wad adjusted to the thickness variation of the fabric, and the fabrics were not bended. The sample length was standardized with respect to a length measured at a temperature of 23° C. After stabilizing the sample, it was heated at a temperature ranged from 30° C. to 180° C. (5° C. per minute) CTE value (α) is induced by the following formula:

α=L₀/(L×(T2−T1))

where, L represents a length variation of sample measured with respect to temperature range (T2−T1), and L₀ represents an original length of sample.

The CTE value was considered to have reliability up to Tg temperature. Accordingly, it is possible to measure CTE value to a temperature where thermal stability is secured despite that an upper limit of the above-mentioned temperature is closely below Tg of a test sample. Data can be plotted by a function of a temperature standardized at 95° C. and variation (%) of length of sample.

2. Thermal Stability

The thermal stability indicated an initiation temperature of 0.2% reduction using TGA (Thermogravimetry Analysis)

### Evaluation Result

The CTE and thermal stability were evaluated by above-mentioned manners.

The CTE of the present invention, as shown in FIG. 4, was 30.63 ppm/° C. We found that when weight reduction was 0.2%, a temperature was 331.37° C. in respect of the thermal stability. Therefore, the CTE and thermal stability of the planarized fabric substrate for the flexible display were dramatically excellent.

Although the present invention has been described herein with reference to the foregoing embodiments and the accompanying drawings, the scope of the present invention is defined by the claims that follow. Accordingly, those skilled in the art will appreciate that various substitutions, modifications and changes are possible, without departing from the spirit of the present invention as disclosed in the accompanying claims. It is to be understood that such substitutions, modifications and changes are within the scope of the present invention.

1. A method for manufacturing a fabric substrate for a flexible display comprising the steps of:
preparing step for preparing a fabric substrate;
calendering step for thermal stability and dimensional stability of the fabric substrate;
a first coating step for coating a first planarization layer for planarizing the calendered fabric substrate;
a plasma processing step for processing plasma to the first planarization layer; and
a second coating step for coating a second planarization layer on the plasma-processed first planarization layer.

2. The method according to claim 1, wherein the fabric substrate is formed of at least one or two or more mixture from the group consisting of polyethylene terephthalate, polyethylene, nylon, and acryl.

3. The method according to claim 1, wherein the calendering step is processed at a temperature ranged from 40° C. to 180° C. and under the condition of 1.5 to 3.5 kg/cm².

4. The method according to claim 3, after the calendering step, wherein a thermal stability has a temperature being more than 300° C. when a weight reduction is 0.2% and a coefficient of thermal expansion (CTE) ranged from 10 to 40 ppm/° C.

5. The method according to claim 1, wherein the first planarization layer is formed of at least one or two or more mixture from the group consisting of silane, polyurethane, and polycarbonate.

6. The method according to claim 5, wherein the silane is formed of at least one or two or more mixture from the group consisting of monosilane (SiH₄), trisilane (Si₃H₈), and tetrasilane (Si₄H₁₀).

7. The method according to claim 5, wherein the silane includes at least one function group selected from the group consisting of epoxy, alkoxy, vinyl, phenyl, methacryloxy, amino, chlorosilane, chloropropyl, and mercapto.

8. The method according to claim 5, wherein the first planarization layer further includes at least one or two or more inorganic mixture from the group consisting of metal oxide, non-metal oxide, nitride, and nitrate.

9. The method according to claim 1, wherein the first coating step forms the first planarization layer using one of a spin-coating, a slot-coating, and a bar-coating and cured at a low temperature ranged from 80° C. to 160° C.

10. The method according to claim 1, wherein the first planarization layer has a thickness of 10 μm to 60 μm and a surface having Ra value of 1 μm to 5 μm.

11. The method according to claim 1, wherein the plasma-processing step is processed in ambient gases of argon (Ar) and oxygen (O₂), a power of 50 to 300 W, and a room temperature plasma at atmospheric temperature.

12. The method according to claim 1, after the plasma processing step, wherein a contact angle of the first planarization layer is less than 10 to 60 degree.

13. The method according to claim 1, wherein the second planarization layer further includes at least one or two or more inorganic mixture from the group consisting of acrylate-based polymer, epoxy-based polymer, amine-based oligomer, and vinyl-based polymer.

14. The method according to claim 13, wherein the second planarization layer further includes a light absorbing agent.

15. The method according to claim 5, wherein the second planarization layer further includes at least one or two or more inorganic mixture from the group consisting of metal oxide, non-metal oxide, nitride, and nitrate.

16. The method according to claim 1, wherein the second coating step forms the second planarization layer using one of a spin-coating, a slot-coating, and a bar-coating and cured at a low temperature ranged from 80° C. to 160° C.

17. The method according to claim 1, wherein a thickness of the second planarization layer has a thickness of 0.01 μm to 1 μm and a surface having Ra value of 10 μm to 500 μm.

18. A method of manufacturing a flexible display device comprising including the planarized fabric substrate in the flexible display manufactured according to the method of claim 1.
